(19) United States
(12) Patent Application Publication
(10) Pub. No.: US 2022/0094646 A1
(43) Pub. Date: Mar. 24, 2022

(54) METHOD AND SYSTEM FOR CENTRAL PROCESSING UNIT EFFICIENT STORING OF DATA IN A DATA CENTER

(71) Applicant: Telefonaktiebolaget LM Ericsson (publ), Stockholm (SE)

(72) Inventors: Chakri PADALA, Bangalore (IN); Joao MONTEIRO SOARES, Solna (SE); Anshu SHUKLA, Bangalore (IN); Ashutosh BISHT, Bangalore (IN); Vinayak JOSHI, Bangalore (IN)

(21) Appl. No.: 17/422,912

(22) PCT Filed: Jan. 17, 2019
(86) PCT No.: PCT/SE2019/050030

§ 371 Date: Jul. 14, 2021

(51) Int. Cl. H04L 49/9005; G06F 15/173; H04L 49/901; H04L 49/90; H04L 67/1097

(52) U.S. Cl. CPC H04L 49/9005; G06F 15/17331; H04L 67/1097; H04L 49/9068; H04L 49/9094; H04L 49/901

(57) ABSTRACT

A method and network interface card providing central processor unit efficient storing of data. The NIC receives request for registering a memory address range in the NIC, the request comprising a rewrite protection granularity for the memory address range. When receiving data from a client process, subsequent to registering of said memory address range, said data having an address within the memory address range, the NIC determines whether the rewrite protection granularity of the NIC is reached, when receiving said data. In the event that the rewrite protection granularity is reached, the NIC inactivates the memory address range according to said reached rewrite protection granularity. The auto-inactivated memory address range also provides a rewrite protection of data when storing data. Remote logging or monitoring of data is also enabled, wherein the logging or monitoring may be regarded to become server-less.

### TECHNICAL FIELD

This disclosure relates to reducing central processor unit (CPU) intervention when storing data. In more particular, it relates to CPU efficient storing of data in a memory in a data center.

### BACKGROUND

Storage class memories (SCM), which are byte-addressable and persistent, i.e. of NVM type, which memories typically fit in dynamic random access memory (DRAM) slots, are expected to be widely deployed in next generation datacenters.

These types of memories have themselves relatively low latency. However, when accessed over normal transport protocols, such as transport control protocol (TCP) or uniform data protocol (UDP), they often incur unwanted software latencies, thereby reducing benefits of said low latency technology.

To reduce latency in software stacks, remote direct memory access (RDMA) is frequently used. A number of applications using such stacks are therefore visualized for the future.

For example, monitoring applications could be realized using persistent memories, where packet data is being collected and stored in a server. The packet data enters the server memory and is persisted in a persistent storage medium, such as a disk. The same analogy can be applicable for server logs.

It has been noted that when using RDMA to SCMs, a server process requires registering of a desired memory address range with the network interface card (NIC), which NIC is connected to, or associated with, the SCM. Once the registration is successful, a server typically informs the client in question of the memory address information.

This registration enables the NIC to write incoming packet data that is addressed to the registered memory, in which packet data is to be written, into a SCM that corresponds to the registered memory.

The server process thereafter provides packet data information to the client. The client may then send the packet data to a specific part of a specified location and the packet data is written directly to the specified memory location by the NIC.

It has been noted that if a server wants to protect written memory pages from being rewritten, there are two ways to achieve this for SCMs using RDMA.

One way would be to have the client in question to send an invalidate notification along with a RDMA write message. Such a notification would invalidate the RDMA write message. However, when huge amounts of memory are registered, this way would require significant book keeping by the NIC that is receiving the RDMA write messages.

A second way is for the server to actively monitor and withdraw memory registrations from the NIC once they are written. This way would require active monitoring by the server and book keeping by the NIC.

Further, if the data store in the NIC is close to full, data needs to be migrated to a secondary storage. This requires active monitoring of an incoming data stream and requires applications running on a CPU to do some but little work, by periodically polling the memory or the incoming packet stream.

In spite of little work done by the CPU, the CPU still needs to maintain resources for polling speedy incoming data streams. In the case of a disaggregated non-volatile dual in-line memory module (NVDIMM) solution, having large amounts of NVDIMM memory, a lot of CPU resources would have to be provisioned.

Also, it has been identified that having a large amount of RDMA addresses registered with the NIC can reduce the RDMA performance of the NIC

There is hence a need for a solution addressing one or more of the issues as discussed above.

### SUMMARY

It is an object of exemplary embodiments to address at least some of the issues outlined above, and this object and others are achieved by a method and a network interface card, according to the appended independent claims, and by the exemplary embodiments according to the dependent claims.

According to an aspect, this disclosure provides a method for providing central processing unit efficient storing of data in a datacenter environment comprising a memory and a network interface card. The method is performed in the network interface card. The method comprises receiving, from a server process, a request for registering a memory address range in the network interface card, the request comprising the memory address range and one or more rewrite protection granularities for the memory address range. The method also comprises registering the memory address range in the network interface card, together with said one or more rewrite protection granularities. Also, the method comprises when receiving, from a client process, data having an address within said memory address range, determining whether one or more rewrite protection granularities of the network interface card have been reached, when receiving said data. In addition, the method comprises, if a rewrite protection granularity of said one or more rewrite protection granularities, has been reached, inactivating the memory address range according to said reached rewrite protection granularity.

According to another aspect, this disclosure provides a network interface card that is capable of providing central processing unit efficient storing of data in a memory. The network interface card and the memory are locatable in a datacenter environment. The network interface card is configured to receive, from a server process, a request for registering a memory address range in the network interface card. The request comprises the memory address range and one or more rewrite protection granularities for the memory address range. The network interface card is also configured to register the memory address range in the network interface card, together with said one or more rewrite protection granularities. Also, the network interface card is configured to receive, from a client process, data having an address within said memory address range. The network interface card is further configured to, after having received said data, determine whether one or more rewrite protection granularities of the network interface card have been reached, upon reception of said data. In addition, the network interface card is further configured to, if a rewrite protection granularity of said one or more rewrite protection granularities has been reached, inactivate the memory address range according to said reached rewrite protection granularity.

The present disclosure brings a number of advantages, of which a few are:

It is advantages that this disclosure provides CPU efficient storing of data in a data center. The disclosure may also increase resource utilization of RDMA hardware. It is also an advantage that the technique within the disclosure is expected to consume less energy than prior art techniques. Also, it is advantageous that storing of data provides an automated rewrite protection of stored data.

The present disclosure may lead to remote logging or monitoring of packet data, wherein the logging or monitoring may be regarded to be server-less.

### BRIEF DESCRIPTION OF THE DRAWINGS

Embodiments will now be described in more detail, and with reference to the accompanying drawings, in which:

FIG. 1 schematically presents a network layout related to the present disclosure;

FIGS. 2A and 2B illustrate a handshake diagram of actions according to embodiments of the present disclosure;

FIGS. 3A and 3B illustrate a flowchart of embodiments of an aspect of the present disclosure; and

FIG. 4 illustrates a flowchart of a method according to an aspect of the present disclosure.

### DETAILED DESCRIPTION

In the following description, different embodiments of the exemplary embodiments will be described in more detail, with reference to accompanying drawings. For the purpose of explanation and not limitation, specific details are set forth, such as particular examples and techniques in order to provide a thorough understanding.

It is herein disclosed a method to provide central processing unit (CPU) efficient storing of data. In addition, by doing so the method decreases the role of a server process when data is being written through remote direct memory access (RDMA) write requests into a memory. The memory may be either a volatile memory or a persistent memory such as a non-volatile memory (NVM). Decreasing the role of the server process is an important advantage as central processing units (CPUs) are expected to become scarce due to an anticipated slowdown of Moore's law. A further advantage is that stored data is rewrite protected by the NIC, based on a rewrite protection granularity.

The disclosure further provides a network interface card (NIC) that provides CPU efficient storing of data in a memory. The NIC may be implemented as part of a field-programmable gate array (FPGA), NIC, such as a smart NIC, or in an application specific integrated circuit (ASIC). The NIC is capable of CPU efficient storing of data, in the sense that the utilization of the CPU may be reduced. Similarly, the NIC has further the advantage that data to be stored by the NIC in the memory are rewrite protected.

Notifications herein as sent from the NIC a server process serve to reduce central processing unit (CPU) requirements of the server.

In prior art, the server has to receive a number of notifications and determine how much of its memory, such as NVM, is getting full.

Moreover, in prior art, rewrite protection require an active server to withdraw memory registrations actively or require a client to actively mark their transmissions to withdraw the memory registration.

By using the present disclosure, the server process is asynchronously sent information about when certain amount of memory is filled.

This disclosure increases the efficiency in that it reduces the role of the server process and increases the efficiency for the NIC to determine the memory address deregistration/inactivation.

For some use cases, packet/data logging, memory addresses may be sequentially filled up. This disclosure may provide an optional parameter to notify the server process how many entries the network interface card can pre-store, which is not possible to configure in the current generation hardware. With the notifications coming from the NIC, the CPU can determine the amount of data that is getting filled up and proportionately provision a number of cache entries to the NIC.

The present disclosure brings enhancements to memory registrations, and reduces CPU interactions in the case of memories, being either volatile memories or non-volatile memories. Non-volatile memories may be storage class memories (SCMs) but this disclosure is also applicable to volatile memories. These enhancements relate to memory registrations of remote direct access memory (RDMA), which moves functionality from software to hardware, thereby reducing the role of a server process. A more efficient resource utilization of both the server and HW resources may thus be achieved.

The number of reduced CPU interactions, typically scales with the capacity of the memory used. As NVM memories have larger capacities than dynamic random access memory (DRAM) memories, the increased efficiency of the present disclosure is typically higher for a NVM memory than for a DRAM memory. Moreover, the capacity difference between NVM memories and DRAM memories is estimated to further increase in the near future. In addition, the persistence aspect of NVM memories is likely to make remote memory access to these memories more wide-spread.

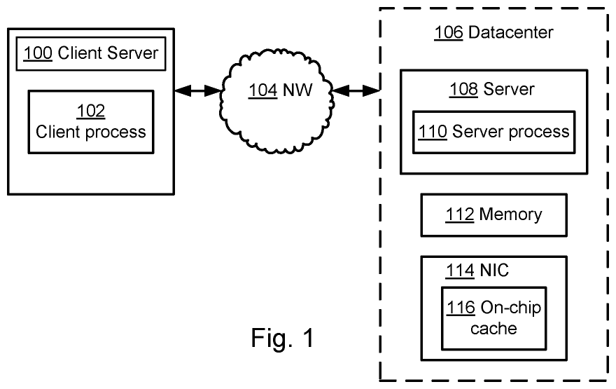

FIG. 1 schematically presents a network layout related to the present disclosure. The layout comprises a client server 100 within which a client process 102 is adapted to run. The client server 100 is connectable to a datacenter 106 over a network (NW) 104. The datacenter 106 comprises a server 108, a memory 112, and a network interface card (NIC) 114. The server 108 comprises a server process 110. The NIC 114 comprises an on-chip cache 116.

Interaction between items of the layout will be explained below.

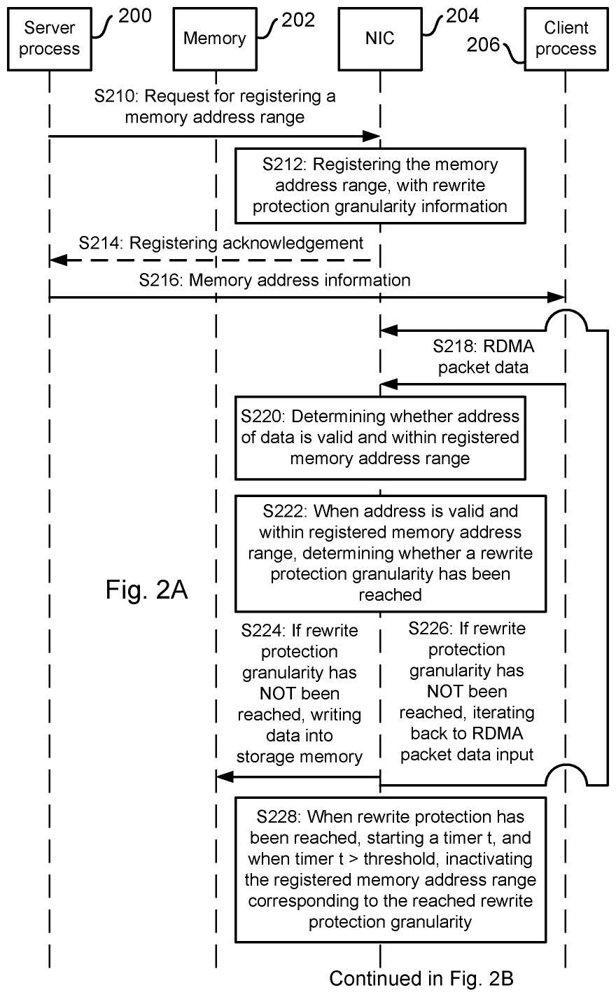

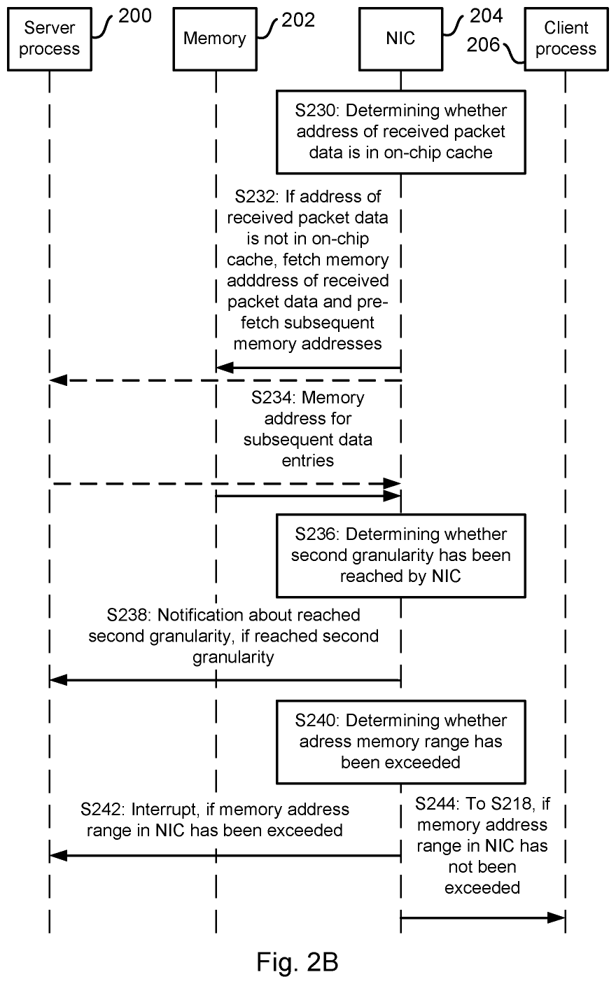

FIGS. 2A and 2B illustrate a handshake diagram of actions according to embodiments of the present disclosure. The handshake diagram comprises interactions between a server process 200, a memory 202, a network interface card (NIC) 204 and a client process 206. The items of FIG. 2A correspond to the items of the layout, as presented in FIG. 1. The memory 202 may be a persistent memory such as a non-volatile memory (NVM).

The handshake diagram comprises:

In S210, the server process sends a request to the NIC 204, for registering a memory address range in the NIC. The request comprises attributes comprising the memory address range and one or more rewrite protection granularities for the memory address range. The request for registering a memory address range may be regarded as a request for auto unregistering the memory address range, i.e. protecting from rewriting data in the memory address range. The one or more rewrite protection granularities for the memory address range may specify an amount of data that can be received before an address range, corresponding to said granularity, is marked as non-writable.

According to one use case, registering the memory address range may comprise registering 100 GB starting at memory address 0x14000. An example of a rewrite protection granularity is 2k bytes (0x800).

The attributes may also comprise a timer threshold, i.e. a duration between the time at which data was last received and the time of un-registering or inactivating the memory address range, to support out of order reception of data in the memory 202.

In addition, the attributes may comprise a value of how large a portion of the memory address range that is to be kept in the NIC, preferably in an on-chip address cache of the NIC.

Also, the attributes may comprise a second granularity at which the NIC informs the server process of filled up address ranges, such as every 10%, 20%, or specific percentages at which the NIC may post events.

The attributes may also comprise a memory address where information is kept of the data page that was last inactivated, i.e. protected from rewriting.

Upon memory registration in the NIC 204, the server process provides the attributes that may be exposed by the NIC 204, along with memory location or address of the memory 202.

In response to the request, the NIC 204 registers S212 the memory address range together with said one or more rewrite protection granularities.

After successful registering of the memory address range, the NIC 204 may then send a registration acknowledgement in S214, to the server process 200, as a response to the request.

In S216, the server process 200 sends memory address information to the client process 206. This memory address information typically comprises information about available capacity in the memory 202 for the client process, and memory address of the memory 202.

In S218, the client process 206 sends data, to be stored, to the NIC. The data is typically received as packet data, and is logged into sequential memory addresses. The NIC receives the data, to be stored in an appropriate memory 202, using direct memory access (DMA).

This is typically done by sending a remote DMA (RDMA) write request to the NIC 204, where the data carries an address.

In S220, the NIC determines whether the address of received data is valid, and whether the address is within the memory address range, as registered in the NIC 204.

The NIC 204 may thus certify that destination address range of arrived data is valid, i.e. that it contains valid addresses, and that it does not overlap with an already protected memory address range.

If the address is valid and is within the registered memory address range of the NIC 204, the NIC determines in S222 whether one or more rewrite protection granularities have been reached, by data receiving the data. These one or more rewrite protection granularities may comprise percentages of how much of the memory address range has been filled by data. These rewrite protection granularities may be considered to be auto-protection rewrite protection granularities, since rewrite protection of data written in the memory will later be performed based on said one or more rewrite protection granularities.

In the use case mentioned above, the NIC may determine whether the NIC has reached an address of 0x14800, since starting from 0x14000 and receiving 0x800 data.

If the NIC 204 in S222 determines that a rewrite protection granularity of said one or more rewrite protection granularities has not been reached, the NIC 204 writes in S224 the received data into the memory 202. The data may here be direct memory accessed into the memory 202.

Also, if the NIC 204 in S222 determines that a rewrite protection granularity of said one or more rewrite protection granularities has not been reached, the handshake diagram iterates back in S226 and returns to S218 of receiving further data from the client process 206, and so on, following the handshake diagram of FIG. 2A.

However, if the NIC 204 determines in S222 that a rewrite protection granularity of said one or more rewrite protection granularities has been reached, the NIC 204 starts a timer t, and at the time when timer t exceeds a pre-set timer threshold, the NIC 204 inactivates S228 the registered memory address range that corresponds to the reached rewrite protection granularity.

Again, according to the use case above, if the NIC determines that the memory address of 0x14800 has been reached, rewrite protection will be performed by inactivating the memory address range of 0x14000 to 0x14800, being an address range of 2k bytes in length. In this use case, the 2k bytes is thus the rewrite protection granularity.

Moreover, if the last address of the data being received reaches an auto protection rewrite protection granularity, i.e. specification of amounts of packet data received before the address range is marked as non-writeable, a timer may be started.

The functionality of this timer may be regarded to be a delay mechanism, with which any data or packets that have been reordered at the sender/network are allowed to be received, During the timer duration or, so called, time out, until timer t expires, i.e. exceeds the time threshold, packet data that has been reordered, will be processed and stored.

At the expiry of this timer this address range is unregistered and no new data can be accepted for addresses in the expired address range.

The handshake diagram of FIG. 2A is continued in FIG. 2B.

In S230, the NIC 204 then determines whether the address of received data is available in the NIC.

If the address of the data is present in the NIC 204, for instance in an on-chip cache 116 of the NIC 204, the destination address is populated into the on-chip cache 116 of the NIC 204 and any invalidated address entries may be removed from the on-chip cache.

However, if data arrives at the NIC with an address that has no match in the on-chip cache 116, the NIC may either inquire the server process 200 for an address entry in the on-chip cache 116 which matches the data. Alternatively, the NIC 204 may perform a search in the memory 202 for such a matching address entry.

When an address entry is obtained, the address entry populates the on-chip cache, and may replace an address entry already present in the on-chip cache.

The NIC 204 may also pre-fetch address entries which are subsequent to the current address for a given memory address range.

If more for instance three address entries are requested in the memory registration for a given client process (the data has a given identity), and after data that typically matches a first address entry of said three address entries, the NIC 204 may pre-fetch the remaining two address entries for the given client. The NIC 204 is then also populated with these remaining two pre-fetched address entries, which prevents performance degradation when these address entries are needed by incoming data. Performance degradation may be prevented by preventing the need to either inquire the server process 200 or perform a search for an address entry that matches given incoming data.

Also, if data that match all said three address entries have been received and rewrite protection has been made, these three address entries may be deleted from the on-chip cache 116, which leaves space for a further address entry to be pre-fetched. This further address entry is typically an address entry range following an address entry range for said three address entries, in this example.

If the memory address of the received data is not present in the NIC 204, the NIC 204 may fetch the current memory address and pre-fetches S232 the memory address(es) for one or more subsequent entries from the memory 112, 202 or the server process 110, 200 into the on-chip cache 116.

It is an advantage that addresses can be pre-fetched into the NIC cache 116 since this prevents performance degradation, in terms of preventing increased latency.

Having fetched information of the current memory address of the received data, the memory address of one or more subsequent entries may hence be pre-fetched from its configuration space in memory 202, in S234.

Further, in S236, the NIC 204 determines whether the NIC has reached a second granularity, or not. This second granularity may comprise an amount of data in number of bytes.

If the NIC 204 determines in S236 that the second granularity has been reached, the NIC 204 sends in S238 a notification that said second granularity has been reached, to the server process 200.

Thus, if the NIC 204 has reached the second granularity of the buffer within the NIC upon receiving the data, an appropriate notification is sent in S238 to the server process.

In addition, in S240 the NIC 204 determines whether the memory address range has been exceeded.

If the memory address range in the NIC has been exceeded, the NIC 204 sends in S242 an interrupt message to the server process 200, to cause an interruption of the server process 200.

Thus, when the NIC 204 reaches an appropriate memory address range threshold, upon receiving said data, an interrupt/notification may be sent to the server process 200.

If the NIC 204 determines in S240 that the memory address range has not been exceeded, the handshake diagram iterates S244 back and continues with S218 of receiving further data from the client process 206.

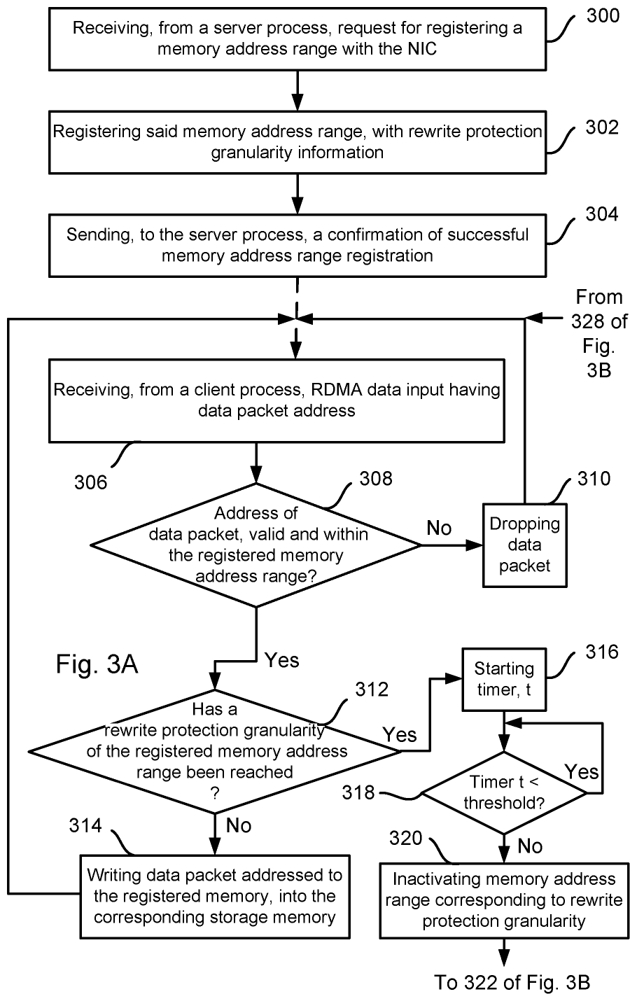

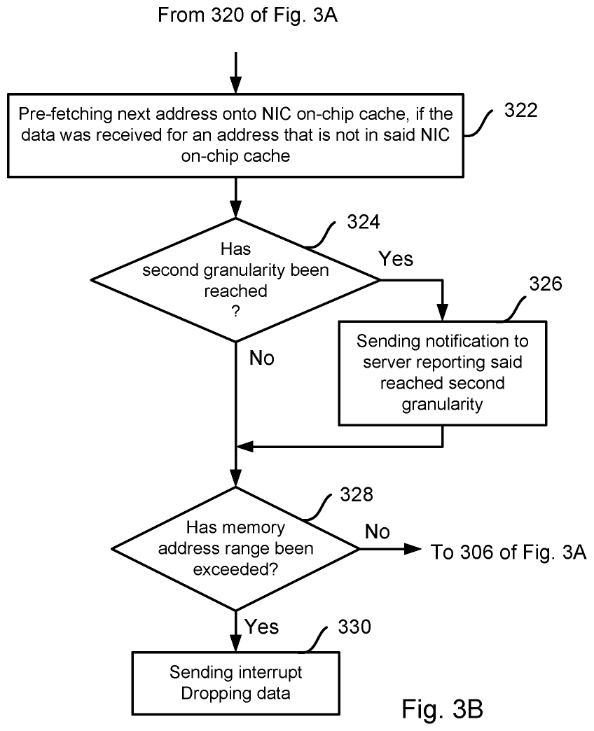

FIGS. 3A and 3B illustrate a flowchart of embodiments of an aspect of the present disclosure. The flowchart comprises actions of a method for providing central processor unit efficient storing of data in a datacenter environment comprising a memory and a network interface card (NIC). The method is performed in the NIC. The memory may be a persistent memory such as a non-volatile memory (NVM).

Action 300: Receiving from a server process a request for registering a memory address range in the NIC. The request comprises attributes comprising the memory address range and one or more rewrite protection granularities for the memory address range.

Action 302: Registering said memory address range together with said one or more rewrite protection granularities. Said one or more rewrite protection granularities may comprise address boundary information, either in the form of bytes or in the form of address percentage being filled with data.

Action 304: Sending to the server process a confirmation of successful memory address range registration.

Action 306: Receiving, from a client process, a data input in the form of a remote direct memory access (RDMA) write request of data, where the data comprises an address.

Action 308: Determining whether the address of the data is valid and within the registered memory address range.

Action 310: Dropping the data, if the data is invalid and/or not within the registered memory address range. The following action is then action 306.

Action 312: If the address of the data is valid and the address in within the registered memory address range, determining whether a rewrite protection granularity of said one or more rewrite protection granularities has been reached.

Action 314: If a rewrite protection granularity of said one or more rewrite protection granularities has not been reached, writing data addressed to the registered memory into the memory.

Action 316: If a rewrite protection granularity of said one or more rewrite protection granularities has been reached, starting a timer t.

Action 318: Determining whether the timer t is below a timer threshold. While timer t is still below the timer threshold, action 318 is repeated.

Action 320: If it is determined that timer t exceeds the timer threshold, inactivating a memory address range that corresponds to the reached rewrite protection granularity.

The flowchart as presented in FIG. 3A is continued on FIG. 3B.

Action 322: Pre-fetch next address onto NIC on-chip cache 116, if the data was received for an address that is not in said NIC on-chip cache. As inactivation of the memory address range that corresponds to the reached rewrite protection granularity, was performed in action 320, the address entry for the current data may be deleted from the on-chip cache 116. A further address entry, following the address range for the deleted address entry, may however be pre-fetched, with which the on-chip cache 116 is populated.

It is noted that pre-fetching an address entry typically refers to fetching an address entry prior to receiving data that matches the said address entry.

Action 324: Determining whether the NIC has reached a second granularity.

Action 326: If the NIC has reached the second granularity, sending a notification to the server process to report reaching of said second granularity.

Action 328: Subsequent to action 326, or if the NIC has not reached the second granularity, determining whether the memory address range has been exceeded.

If the memory address range has not been exceeded, the flowchart continues with action 306, as presented in FIG. 3A.

Action 330: If the memory address range has been exceeded, the NIC sends an interrupt to the server process, and drops the data.

The flowchart may thereafter be reiterated, thus repeating the flowchart as presented in FIGS. 3A and 3B, to start with action 300 for registering of a further memory address range with the NIC.

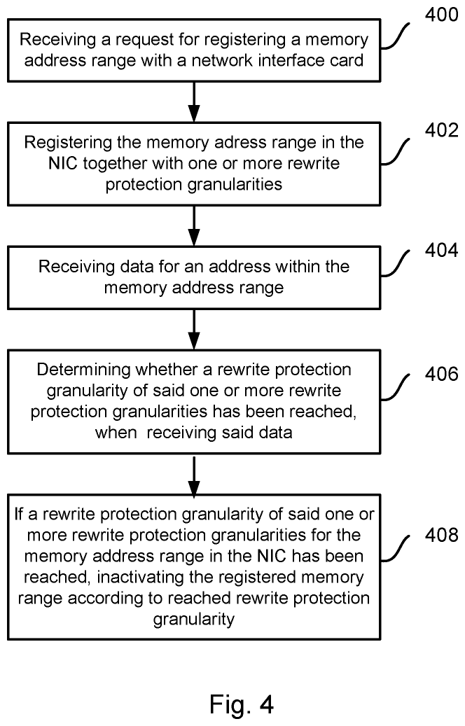

FIG. 4 presents a flowchart of a method according to an aspect of the present disclosure. This flowchart comprises actions of a method for providing rewrite protection of data when storing sequential data in a datacenter environment comprising a memory and a network interface card (NIC) 204. The memory may be a persistent memory such as a non-volatile memory (NVM). The method is performed by the NIC 204.

Action 400: Receiving, from a server process, a request for registering a memory address range with the NIC. The request comprises the memory address range and one or more rewrite protection granularities for the memory address range.

Action 402: Registering the memory address range in the NIC, together with said one or more rewrite protection granularities for the memory address range.

Action 404: Receiving data from a client process, where the data has an address is for an address within said memory address range.

Receiving the data may comprise receiving a remote direct memory access (RDMA) write request of the data.

Action 406: Determining whether a rewrite protection granularity of said one or more rewrite protection granularities has been reached, when the received data is addressed for the memory address range.

Action 408: If a rewrite protection granularity of said one or more rewrite protection granularities for the memory address range in the NIC 204 has been reached, inactivating the registered memory address range according to the reached rewrite protection granularity.

The flowchart may further comprise starting a timer upon reaching the rewrite protection granularity of the NIC 204, and wherein action 408 of inactivating the memory address range is not performed until the timer expires, i.e. the timer t exceeds a pre-set timer threshold.

Action 408 of inactivating the memory address range may comprise inactivating the memory address range to an extent that corresponds to the reached rewrite protection granularity.

The flowchart may also comprise, if said rewrite protection granularity of said one or more rewrite protection granularities for the memory address range has not been reached, writing 314 the received data into the memory, and iteratively performing further receiving 404 data, the determining 406 whether a rewrite protection granularity of said one or more rewrite protection granularities of the NIC 204 has been reached when further receiving data; and, if a rewrite protection granularity of said one or more rewrite protection granularities for the memory address range in the NIC 204 has been reached, the inactivating 408 of the memory address range according to said reached rewrite protection granularity.

The flowchart may also comprise, in the event of the NIC 204 has reached a second granularity, notifying S238, 326 the server process that the second granularity has been reached.

The flowchart may also comprise, while the memory address range has not been exceeded, iteratively performing further receiving 404 data, determining 406 whether a rewrite protection granularity of said one or more rewrite protection granularities of the NIC 204 has been reached when further receiving data; and, if a rewrite protection granularity of said one or more rewrite protection granularities for the memory address range in the NIC has been reached, inactivating 408 of the memory address range according to said reached rewrite protection granularity.

Also, the flowchart may comprise pre-fetching S232, S234, 322 one or more cache address entries from either the memory 112, 202 ro the server process 100, 200 into the NIC on-chip cache 116.

In addition, the flowchart may also comprise, if the memory address range has been exceeded, sending S242, 330 an interrupt instruction to the server process.

The present disclosure also provides a network interface card (NIC) 114, 204 that is capable of providing central processor unit efficient storing of data in a memory 202. The NIC 114, 204 and the memory 202 are locatable in a datacenter environment. The memory may be a persistent memory such as a non-volatile memory (NVM). The NIC 114, 204 is configured to receive, from a server process, a request for registering a memory address range in the NIC 114, 204. The request comprises the memory address range and one or more rewrite protection granularities for the memory address range. The NIC 114, 204 is also configured to register the memory address range in the NIC 114, 204, together with said one or more rewrite protection granularities. Also, the NIC 114, 204 is configured to receive, from a client process, data having an address within said memory address range. The NIC 114, 204 is further configured to, after having received said data, determine whether one or more rewrite protection granularities of the NIC 114, 204 have been reached, upon reception of said data. In addition, the NIC 114, 204 is further configured to, if a rewrite protection granularity of said one or more rewrite protection granularities, has been reached, inactivate the memory address range according to said reached rewrite protection granularity.

The NIC 114, 204 may further be configured to receive a remote direct memory access (RDMA) write request of said data.

The NIC 114, 204 may also be configured to start a timer upon reaching a rewrite protection granularity of the NIC. The NIC 114, 204 may also be configured to not inactivate the memory address range, until the timer t expires, i.e. exceeds a pre-set timer threshold.

The NIC 114, 204 may also be configured to inactivate the memory address range to an extent that corresponds to a reached rewrite protection granularity.

Also, the NIC 114, 204 may be configured to, if said rewrite protection granularity of said one or more rewrite protection granularities for the memory address range has not been reached, write the received data into the memory, iteratively further perform: receive, from a client process, further data having an address within said memory address range, determine whether one or more rewrite protection granularities of the NIC have been reached; and, if the rewrite protection granularity of said one or more rewrite protection granularities has been reached, inactivate the memory address range according to said reached rewrite protection granularity.

The NIC 114, 204 may also be configured to, where the data are sequential, if a second granularity has been reached, notify the server process that the second granularity has been reached.

In addition, the NIC 114, 204 may be configured to, while the memory address range has not been exceeded, iteratively perform: receive, from a client process, further data having an address within said memory address range, determine whether one or more rewrite protection granularities of the NIC 114, 204 have been reached; and, if a rewrite protection granularity of said one or more rewrite protection granularities has been reached, inactivate the memory address range according to said reached rewrite protection granularity.

Also, the NIC 114, 204 may be configured to pre-fetch one or more cache address entries from either its configuration in memory 112, 202 or the server process 110, 200 into a NIC on-chip cache 116.

The NIC 114, 204 may also be configured to, if the memory address range has been exceeded, send an interrupt instruction to the server process.

The NIC 114, 204 may further be comprised within a field-programmable gate array (FPGA) NIC. The NIC may further be implemented as a FPGA or as an application specific integrated circuit (ASIC).

Advantages of at least some of the embodiments as disclosed herein.

It is an advantage that this disclosure provides CPU efficient storing of data in a data center. It may increase resource utilization of RDMA hardware. It is also an advantage that the technique within the disclosure is expected to consume less energy than prior art techniques.

Also, it is advantageous that storing of data within the method provides an automated rewrite protection of stored data, using a rewrite protection granularity.

The present disclosure may lead to remote logging or monitoring of packet data, wherein the logging or monitoring may be regarded to become server-less.

Abbreviations

ASIC application specific integrated circuit

CPU central processing unit

DMA direct access memory

FPGA field-programmable gate array

GPU graphical processing unit

HW hardware

NIC network interface card

NVM non-volatile memory

NVDIMM non-volatile dual in-line memory module

SCM store class memory

RDMA remote DMA

1. A method for providing central processor unit efficient storing of data in a datacenter environment comprising a memory and a network interface card, NIC, the method being performed in the NIC, the method comprising:
receiving, from a server process, a request for registering a memory address range in the NIC, the request comprising the memory address range and one or more rewrite protection granularities for the memory address range;
registering the memory address range in the NIC, together with the one or more rewrite protection granularities;
when receiving, from a client process, data having an address within the memory address range:
determining whether one or more rewrite protection granularities of the NIC have been reached, when receiving the data;
if a rewrite protection granularity of the one or more rewrite protection granularities, has been reached, inactivating the memory address range according to said reached rewrite protection granularity; and
starting a timer upon reaching the rewrite protection granularity of the NIC, inactivating the memory address range not being performed until the timer exceeds a pre-set timer threshold.

2. The method, according to claim 1, wherein receiving data comprises receiving a remote direct memory access, RDMA, write request of data.

3. (canceled)

4. The method according to claim 1, wherein inactivating the memory address range, comprises inactivating the memory address range to an extent that corresponds to the reached rewrite protection granularity.

5. The method according to claim 1, further comprising, if the rewrite protection granularity of the one or more rewrite protection granularities has not been reached, writing the received data into the memory, and iteratively further performing the receiving of data, the determining whether one or more rewrite protection granularities of the NIC have been reached by further receiving data; and, if a rewrite protection granularity of the one or more rewrite protection granularities has been reached, inactivating of the memory address range according to the reached rewrite protection granularity.

6. The method according to claim 1, wherein the data are sequential, and the method further comprises, if a second granularity has been reached by the NIC, notifying the server process that the second granularity has been reached.

7. The method according to claim 1, further comprising while the memory address range has not been exceeded, iteratively performing the receiving of data, the determining whether one or more rewrite protection granularities of the NIC have been reached, by further receiving data; and, if the rewrite protection granularity of the one or more rewrite protection granularities, has been reached, inactivating of the memory address range according to said reached rewrite protection granularity.

8. The method according to claim 1, further comprising pre-fetching one or more cache address entries from one of the memory and the server process into a NIC on-chip cache.

9. The method according to claim 1, further comprising if the memory address range has been exceeded, sending an interrupt instruction to the server process.

10. A network interface card, NIC, capable of providing central processor unit efficient storing of data in a memory, the NIC and the memory being locatable in a datacenter environment, the NIC being configured to:
receive, from a server process, a request for registering a memory address range in the NIC, the request comprising the memory address range and one or more rewrite protection granularities for the memory address range;
register the memory address range in the NIC, together with the one or more rewrite protection granularities;
receive, from a client process, data having an address within said memory address range, and when having received the data further:
determine whether one or more rewrite protection granularities of the NIC have been reached, upon reception of the data; and
if a rewrite protection granularity of said one or more rewrite protection granularities, has been reached, inactivate the memory address range according to the reached rewrite protection granularity; and
start a timer upon reaching the rewrite protection granularity of the NIC, inactivating the memory address range not being performed until the timer exceeds a pre-set timer threshold.

11. The NIC according to claim 10, further configured to receive a remote direct memory access, RDMA, write request of the data.

12. (canceled)

13. The NIC according to claim 10, further configured to inactivate the memory address range to an extent that corresponds to the reached rewrite protection granularity.

14. The NIC according to claim 10, further configured to, if the rewrite protection granularity of the one or more rewrite protection granularities, has not been reached, write the received data into the memory, and to iteratively further perform: receive, from a client process, further data having an address within the memory address range, determine whether one or more rewrite protection granularities of the NIC have been reached; and, if the rewrite protection granularity of the one or more rewrite protection granularities has been reached, inactivate the memory address range according to the reached rewrite protection granularity.

15. The NIC according to claim 10, where the data are sequential, and the NIC further is configured to, if a second granularity has been reached, notify the server process that the second granularity has been reached.

16. The NIC according to claim 10, further configured to, while the memory address range has not been exceeded, iteratively perform: receive, from a client process, further data having an address within said memory address range, determine whether one or more rewrite protection granularities of the NIC have been reached; and, if the rewrite protection granularity of the one or more rewrite protection granularities has been reached, inactivate the memory address range according to the reached rewrite protection granularity.

17. The NIC according to claim 10, further being configured to, if the memory address range has been exceeded, send an interrupt instruction to the server process.

18. The NIC according to claim 10, wherein the NIC comprises a field-programmable gate array, FPGA, NIC.

19. The method according to claim 2, wherein inactivating the memory address range, comprises inactivating the memory address range to an extent that corresponds to the reached rewrite protection granularity.

20. The method according to claim 2, further comprising, if the rewrite protection granularity of the one or more rewrite protection granularities has not been reached, writing the received data into the memory, and iteratively further performing the receiving of data, the determining whether one or more rewrite protection granularities of the NIC have been reached by further receiving data; and, if a rewrite protection granularity of the one or more rewrite protection granularities has been reached, inactivating of the memory address range according to the reached rewrite protection granularity.

21. The method according to claim 2, wherein the data are sequential, and the method further comprises, if a second granularity has been reached by the NIC, notifying the server process that the second granularity has been reached.

22. The NIC according to claim 10, further configured to pre-fetch one or more cache address entries, from one of the memory and the server process, into a NIC on-chip cache.
